(19) United States
(12) Patent Application Publication
(10) Pub. No.: US 2024/0220809 A1
(43) Pub. Date: Jul. 4, 2024

(54) CONTINUAL LEARNING METHOD AND APPARATUS

(71) Applicant: KOREA ADVANCED INSTITUTE OF SCIENCE AND TECHNOLOGY, Daejeon (KR)

(72) Inventors: Changdong YOO, Daejeon (KR); Haeyong KANG, Daejeon (KR)

(21) Appl. No.: 18/392,227

(22) Filed: Dec. 21, 2023

(30) Foreign Application Priority Data
Dec. 22, 2022 (KR) 10-2022-0181588
Dec. 11, 2023 (KR) 10-2023-0178783

(51) Int. Cl. G06N 3/091; G06N 3/045

(52) U.S. Cl. CPC G06N 3/091; G06N 3/045

(57) ABSTRACT

A computing device performs a continual learning method of learning a plurality of task in a sequential order. The computing device uses, in a forward pass of a neural network for learning a current task of the plurality of tasks, a plurality of weights including selected weights, the selected weights being selected in a previous task of the plurality of tasks, freezes the selected weights and updates weights excluding the selected weights from the plurality of weights in a backward pass of the neural network for learning the current task, obtains a binary mask for selecting some weights of the plurality of weights based on a weight score of each of the plurality of weights, and finds a subnetwork of the neural network for the current task based on the binary mask.

### CROSS-REFERENCE TO RELATED APPLICATION

This application claims priority to and the benefit of Korean Patent Application Nos. 10-2022-0181588 filed on Dec. 22, 2022, and 10-2023-0178783 filed on Dec. 11, 2023, in the Korean Intellectual Property Office, the entire contents of which are incorporated herein by reference.

### BACKGROUND

### (a) Field

The disclosure relates to a continual learning method and apparatus.

### (b) Description of the Related Art

Continual learning, also known as lifelong learning, is a paradigm for learning a series of tasks in a sequential manner. One of the major goals in the continual learning is to mimic human cognition, exemplified by the ability to incremental learning new concepts over his/her lifespan. An ideal continual learner encourages positive forward/backward transfer, utilizing the learned knowledge from previous tasks when solving for new ones, and updating the previous task knowledge with the new task knowledge. Nevertheless, this is nontrivial due to the phenomenon referred to as catastrophic forgetting or catastrophic interference where the model performance on previous tasks significantly decreases upon learning on new tasks.

### SUMMARY

Some embodiments may provide a continual learning method and apparatus for preventing a risk of catastrophic forgetting.

According to some embodiments, a continual learning method of learning a plurality of task in a sequential order, performed by a computing device may be provided. The method may include using, in a forward pass of a neural network for learning a current task of the plurality of tasks, a plurality of weights including selected weights, the selected weights being selected in a previous task of the plurality of tasks; freezing the selected weights and updating weights excluding the selected weights from the plurality of weights, in a backward pass of the neural network for learning the current task; obtaining a binary mask for selecting some weights of the plurality of weights based on a weight score of each of the plurality of weights; and finding a subnetwork of the neural network for the current task based on the binary mask.

According to some embodiments, a continual learning apparatus may include a memory configured to store one or more instructions and a processor. The processor may be configured to, by executing one or more instructions, use, in a forward pass of a neural network for learning a current task of the plurality of tasks, a plurality of weights including selected weights, the selected weights being selected in a previous task of the plurality of tasks; freeze the selected weights and update weights excluding the selected weights from the plurality of weights, in a backward pass of the neural network for learning the current task; obtain a binary mask for selecting some weights of the plurality of weights based on a weight score of each of the plurality of weights; and find a subnetwork of the neural network for the current task based on the binary mask.

According to some embodiments, a computer program stored in a non-transitory computer-readable storage medium and executed by a computing device may be provided. The computer program may configure the computing device to execute using, in a forward pass of a neural network for learning a current task of a plurality of tasks, a plurality of weights including selected weights, the selected weights being selected in a previous task of the plurality of tasks; freezing the selected weights and updating weights excluding the selected weights from the plurality of weights, in a backward pass of the neural network for learning the current task; obtaining a binary mask for selecting some weights of the plurality of weights based on a weight score of each of the plurality of weights; and finding a subnetwork of the neural network for the current task based on the binary mask.

### BRIEF DESCRIPTION OF THE DRAWINGS

FIG. 1 is a drawing for explaining a continual learning method according to some embodiments.

FIG. 2 is a diagram illustrating a continual learning apparatus according to some embodiments.

FIG. 3, FIG. 4, FIG. 5, and FIG. 6 each are diagrams illustrating a process of a continual learning method according to some embodiments.

FIG. 7 and FIG. 8 are diagrams illustrating compression of a binary mask in a continual learning method according to some embodiments.

FIG. 9 is a flowchart of a continual learning method according to some embodiments.

FIG. 10 is a block diagram of a computing device according to some embodiments.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

The order of operations or steps may be changed, several operations or steps may be merged, a certain operation or step may be divided, and a specific operation or step may not be performed.

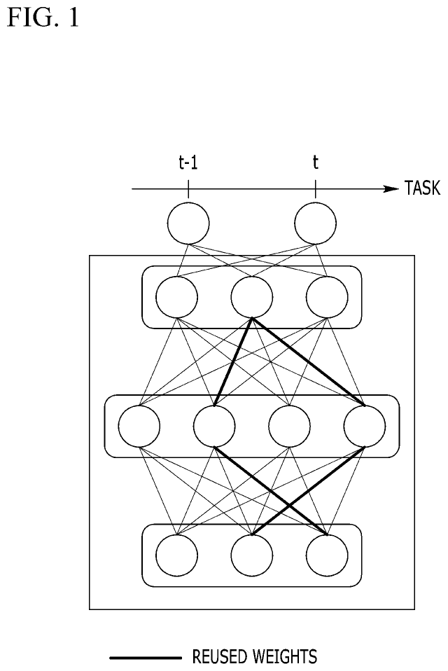

FIG. 1 is a drawing for explaining a continual learning method according to some embodiments.

Referring to FIG. 1, a continual learning method according to some embodiments may learn a subnetwork for a current task (task t) while keeping weights selected by a previous task (task t-1). In FIG. 1, edges (weights) represented by bold lines may be weights (reused weights) that are reused and frozen in the current task t among the weights selected in the previous task t-1

Recent studies have shown that deep neural networks are over-parameterized and thus removing redundant or unnecessary weights can achieve on-par or even better performance than the original dense network. More recently, in “The lottery ticket hypothesis: Finding sparse, trainable neural networks,” In Proceedings of the International Conference on Learning Representations (ICLR), 2019, Frankle and Carbin demonstrate the existence of sparse subnetworks, named winning tickets, that preserve the performance of a dense network. However, searching for optimal winning tickets during continual learning with iterative pruning methods requires repetitive pruning and retraining for each arriving task, which may be impractical.

A pruning-based continual learning approach, proposed by Mallya et al. in “Piggyback: Adapting a single network to multiple tasks by learning to mask weights,” In Proceedings of the European Conference on Computer Vision (ECCV), 2018, may obtain task-specific subnetworks given a pre-trained (i.e., fixed) backbone network. However, the continual learning method according to some embodiments may incrementally learn model weights and task-dependent binary masks (subnetworks) within the neural network.

Further, a continual learning method, proposed by Mallya and Lazebnik in “Packnet: Adding multiple tasks to a single network by iterative pruning,” In Proceedings of the IEEE International Conference on Computer Vision and Pattern Recognition (CVPR), 2018, may all weights that may lead to biased transfer to allow forward transfer when a model learns on a new task. However, the continual learning method according to some embodiments may reuse learned subnetwork weights for previous tasks.

Furthermore, a continual learning method, proposed by Yoon et al. in “Lifelong learning with dynamically expandable networks,” In Proceedings of the International Conference on Learning Representations (ICLR), 2018, can update subnetwork weights for the previous tasks when training on a new task. However, the continual learning method according to some embodiments may eliminate the threat of catastrophic forgetting during continual learning by freezing the subnetwork weights for the previous tasks, and may not suffer from negative transfer.

Magnitudes of the weights may be often used as a pruning criterion for finding an optimal subnetwork. However, in continual learning, relying only on the weight magnitude may be suboptimal since the weights are shared across classes, and thus training on new tasks may change the weights trained for previous tasks (reused weights). This may trigger an effect where weights selected to be part of the subnetworks for later tasks are always better in a continual learning apparatus, which may result in catastrophic forgetting of the knowledge for the prior tasks. Thus, in the continual learning, it may be important for the continual learning apparatus to train on the new tasks without changing the reused weights.

Accordingly, in some embodiments, the continual learning method may decouple information of a learning parameter and a network structure into two separate learnable parameters, namely, weights and weight scores, to find the optimal subnetworks. The weight scores may be binary masks that have the same shapes as the weights. The continual learning apparatus may find subnetworks by selecting the weights with the top-c percent (c %) weight scores. In some embodiments, the continual learning apparatus may jointly learn the weights and the weight scores. As such, decoupling the weights and the subnetwork structure may allow the continual learning apparatus to find the optimal subnetwork without iterative retraining, pruning, and rewinding, which can improve computational efficiency (or CPU utilization) by reducing the workload on a processor such as a central processing unit (CPU) of a computing device. Further, using the optimal subnetwork instead of the dense network for each task can improve a memory efficiency of the computing device (e.g., prevent the increase in memory capacity).

In some embodiments, the continual learning method may be a forgetting-free continual learning method, which learns a compact subnetwork for each task while keeping the weights selected by the previous tasks, and may not perform any explicit pruning for learning the subnetwork. Accordingly, the continual learning method may not only eliminate catastrophic forgetting but also enable forward transfer from the previous tasks to new tasks.

In some embodiments, the continual learning method may obtain compact subnetworks with a sub-linear increase in the network capacity, outperforming existing continual learning methods in terms of accuracy-capacity trade-off and backward transfer.

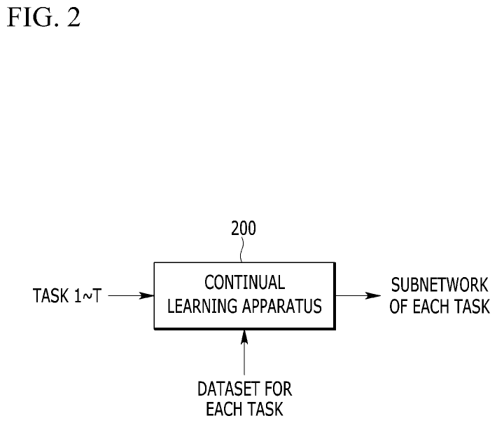

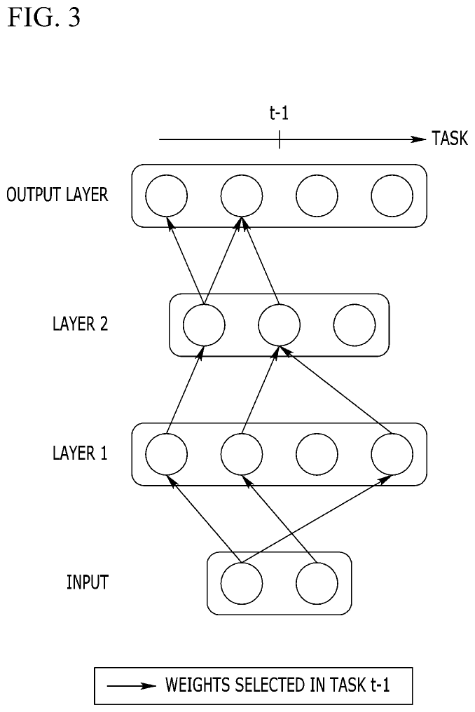

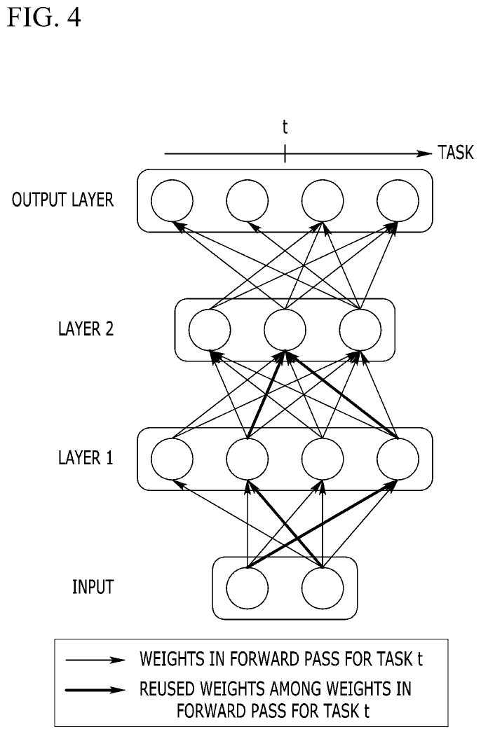

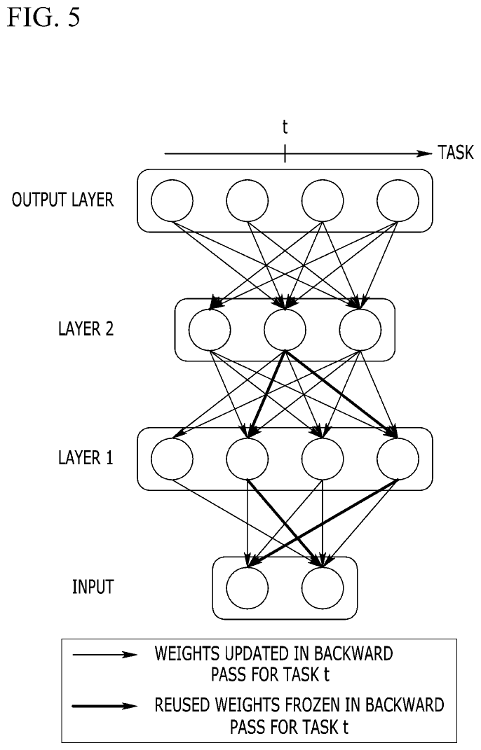

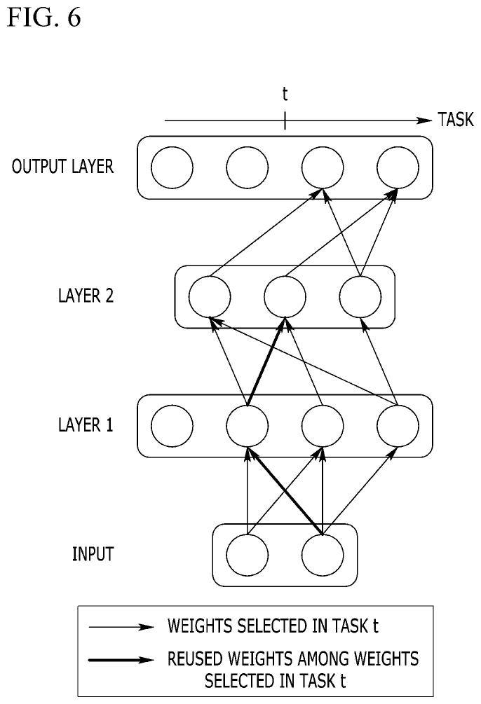

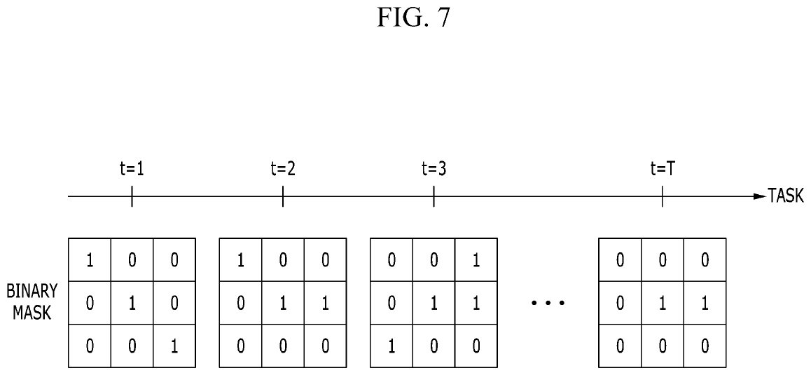

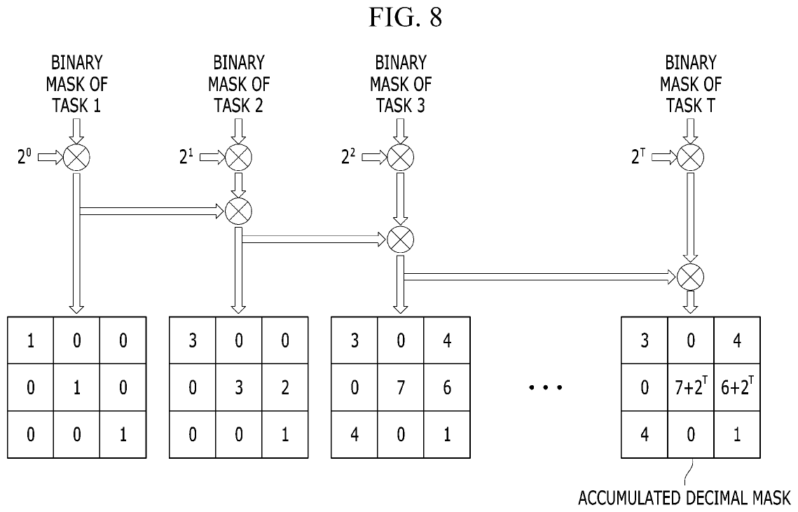

FIG. 2 is a diagram illustrating a continual learning apparatus according to some embodiments, FIG. 3, FIG. 4, FIG. 5, and FIG. 6 each are diagrams illustrating a process of a continual learning method according to some embodiments, and FIG. 7 and FIG. 8 are diagrams illustrating compression of a binary mask in a continual learning method according to some embodiments.

Referring to FIG. 2, T tasks (task 1 to task T) may arrive to a continual learning apparatus 200 in a sequential order, and the continual learning apparatus 200 may sequentially learn the T tasks. The continual learning apparatus 200 may receive a data set for learning each task. The dataset Dₜ, for task t (e.g., the t^{th} task) among the T tasks may be represented as Equation 1, where t is an integer between 1 and T. In some embodiments, the data set Dₜ, for task t may be only accessible when task t is being learned. In some embodiments, a task identity may be given to each task for task identification. After learning each task, the continual learning apparatus 200 may find a subnetwork of a neural network for that task.

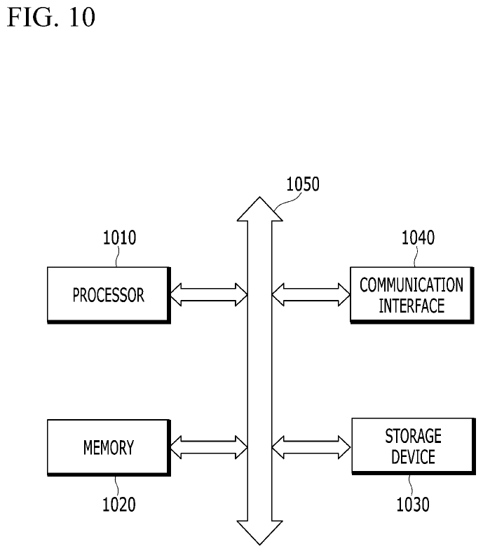

The continual learning apparatus 200 may be a computing device that performs continual learning for a neural network. In some embodiments, the computing device may be, but is not limited to, a notebook, desktop, laptop, server, or the like, and may be any type of device with computing functions. An example of the computing device is described with reference to FIG. 10.

$${𝒟}_{t} = {\{ {x}_{i , t} , {y}_{i , t} \}}_{i = 1}^{m} \qquad Equation 1$$

In Equation 1, x_{i,t} denotes a raw instance (e.g., raw data), y_{i,t} denotes a label corresponding to x_{i,t}. Accordingly, the dataset may include n, pairs of raw instances and labels.

Hereinafter, a continual learning model of the continual learning apparatus 200 is represented as a neural network f(·; θ) parameterized by the model weights θ. A continual learning scenario of the continual learning apparatus 200 may aim to learn a sequence of tasks by solving optimization procedure at each step t (i.e., task t). The optimization procedure may be a procedure that minimizes a loss. In some embodiments, the loss may be a classification objective loss such as a cross-entropy loss. The model weights θ* optimized by the optimization procedure may be given by, for example, Equation 2.

$${θ}^{*} = {minimize}_{θ} \frac{1}{{n}_{t}} {\sum }_{i = 1}^{{n}_{i}} ℒ ( f ( {x}_{i , t} ; θ ) , {y}_{i , t} ) \qquad Equation 2$$

In Equation 2, [symbol] (·;) is the classification objective loss such as cross-entropy loss.

In some embodiments, the continual learning apparatus 200 may find subnetworks that obtain on-par or even better performance than the neural network (e.g., deep neural network). For example, as continual learning often adopts an over-parameterized deep neural network to allow resource freedom for future tasks, the continual learning apparatus 200 may find subnetworks that obtain on-par or even better performance than the deep neural network.

The continual learning apparatus 200 may associate each weight of the neural network with a learnable parameter, called a weight score s, which numerically determines an importance of weight associated with the weight score s. That is, a weight with a higher weight score s may be seen as more important. The continual learning apparatus 200 may find a subnetwork \hat{θ}ₜ of the neural network and assign it as a solver of a current task t. The continual learning apparatus 200 may find the subnetwork \hat{θ}ₜ by selecting the c % weights with the highest weight scores s, where c a target layerwise capacity ratio in %. The subnetwork may be used instead of the whole original network as a solver of a current task because (1) the lottery ticket hypothesis of Frankle and Carbin shows the existence of a subnetwork that performs as well as the whole network, and (2) the subnetwork requires less capacity than dense networks, and therefore it inherently reduces the size of the expansion of the solver.

Next, a method of obtaining a subnetwork θₜ for a current task T in the continuous learning apparatus 200 is described with reference to FIG. 3 to FIG. 6. In FIG. 3 to FIG. 6, a neural network is shown to include an input layer, a layer 1, a layer 2, and an output layer for ease of description, but the number of layers is not limited thereto. Further, in FIG. 3 to FIG. 6, an edge connecting a node in one layer to a node in the other layer may correspond to a weight.

Referring to FIG. 3, the continuous learning apparatus 200 may first find a subnetwork \hat{θ}ₜ₋₁ of a neural network for a previous task t-1. That is, as shown in FIG. 3, some weights of the neural network may be selected to find the subnetwork \hat{θ}ₜ₋₁. The method of finding the subnetwork \hat{θ}ₜ₋₁ for the previous task t-1 may be substantially the same as the method of finding the subnetwork \hat{θ}ₜ for the current task t, which is discussed below.

As shown in FIG. 4 and FIG. 5, the continuous learning apparatus 200 may learn the neural network by repeating a learning process using each batch of the dataset Dₜ for the current task t.

Referring to FIG. 4, the continual learning apparatus 200 may input a raw instance x_{i,t} of each batch for the current task t into the layers of the neural network for the current task t to perform an inference process on a forward pass. The continuous learning apparatus 200 may reuse weights selected in the previous task t-1 in the forward pass of the neural network for learning the current task t. For example, as shown in FIG. 4, if there are weights (i.e., edges) selected in the previous task t-1 among weights (i.e., edges) in the forward pass of the current task t, the continuous learning apparatus 200 may reuse the weights selected in the previous task t-1.

Referring to FIG. 5, the continuous learning apparatus 200 may update the weights in a backward pass of the neural network for learning the current task t based on a result inferred in the forward pass. In this case, the continuous learning apparatus 200 may not update the reused weights (i.e., the weights selected in the previous task t-1) but may update other weights (unused weights). In some embodiments, the continuous learning apparatus 200 may calculate a loss between the result of inference in the forward pass and a label y_{i,t} assigned to the raw instance x_{i,t} input to the forward pass, and update the weights based on the loss. The loss for the input batch X_{i,t} may be given by, for example, [symbol] f(x_{i,t}: θ), y_{i,t}).

The continuous learning apparatus 200 may learn the current task t of the neural network by repeating the process shown in FIG. 4 and FIG. 5 for each batch of the dataset Dₜ.

Referring to FIG. 6, the continuous learning apparatus 200 may find a subnetwork \hat{θ}ₜ₋₁ by selecting the c % weights with the highest weight scores s where c is the target layerwise capacity ratio in %. The selection of weights may be represented by a task-dependent binary mask mₜ, where a value of 1 may denote that the weight is selected during the forward pass and a value of 0 may denote that the weight is not selected during the forward pass. The binary mask mₜ, may be obtained by applying a indicator function [symbol] _{c} on the weight score s where [symbol] _{c} (s)=1 if the weight score s belongs to top-c % scores and [symbol] _{c}(s)=0 if the weight score s does not belong to the top-c % scores. Therefore, the subnetwork \hat{θ}ₜ₋₁ for the task t may be obtained by Equation 3.

$${\hat{θ}}_{i} = θ ⊙ {m}_{i} \qquad Equation 3$$

In some embodiments, to jointly learn the model weights and the binary mask of a subnetwork associated with each task, given a loss [symbol] (·), the continual learning apparatus 200 may optimize θ and s as, for example, Equation 4.

$${minimize}_{θ , s} ℒ ( θ ⊙ {m}_{i} ; {𝒟}_{i} ) \qquad Equation 4$$

However, this vanilla optimization procedure may present two problems: (1) updating all the weights θ when training for a new task may cause interference to the weights allocated for previous tasks, and (2) because the indicator function may always have a gradient value of 0, updating the weight scores s with its loss gradient may be not possible.

In some embodiments, to solve the first problem, the continual learning apparatus 200 may selectively update the weights by allowing updates only on the weights that have not been selected in the previous task t-1. To do that, the continual learning apparatus 200 may use an accumulate binary mask Mₜ₋₁ to update the weights θ when learning the task t. In some embodiments, the accumulate binary mask Mₜ₋₁ may be given as in Equation 5. In some embodiments, the continual learning apparatus 200 may update the weight θ using a mask obtained subtracting the accumulated mask vᵢ₌₁^{t-}1Mₜ up to the previous task t-1 from one. For example, the continual learning apparatus 200 may use an optimization technique with a learning rate n to update the weights θ as shown in Equation 6. Accordingly, the continual learning apparatus 200 may effectively freeze the weights of the subnetwork selected in the previous task t-1.

$${M}_{t - 1} = {V}_{i = 1}^{t - 1} {m}_{i} \qquad Equation 5$$

$$θ ← θ - η ( \frac{\partial ℒ}{\partial θ} ⊙ ( 1 - {M}_{t - 1} ) ) \qquad Equation 6$$

To solve the second problem, the continual learning apparatus 200 may use a straight-through estimator in the backward pass since mₜ, is obtained by top-c % scores. The continual learning apparatus 200 may ignore the derivatives of the indicator function [symbol] _{c} and update the weight scores since the indicator function [symbol] _{c} always has the gradient value of 0. The straight-through estimator may be described in, for example, Hinton, “Neural networks for machine learning,” 2012, Bengio, et al. “Estimating or propagating gradients through stochastic neurons for conditional computation,” CoRR, 2013, and Ramanujan, et al. “What's hidden in a randomly weighted neural network?” In Proceedings of the IEEE International Conference on Computer Vision and Pattern Recognition (CVPR), 2020. For example, the continual learning apparatus 200 may update the weight score s as shown in Equation 7.

$$s ← s - η ( \frac{\partial ℒ}{\partial s} ) \qquad Equation 7$$

The use of separate weight scores s as the basis for selecting subnetwork weights may make it possible to reuse some of the weights from previously selected weights in solving the current task t, which may be viewed as transfer learning. In other words, the weights selected for the current task t may include some of the weights selected for the previous task t-1. Likewise, previously selected weights that are irrelevant to the new task may be not selected, instead, weights from a set of not-yet-selected weights may be selected to meet the target network capacity for each task, which may be viewed as finetuning from the tasks {1, . . . , t-1} to the task t.

In some embodiments, the above-described continual learning method may be summarized in the below algorithm 1.

Algorithm 1
input { [symbol] } [symbol] model weights θ, score weights s, binary mask

| | M₀ = [symbol] , layer-wise capacity c | |
|---|---|---|
| 1: | Randomly initialize θ and s. | |
| 2: | for task t = 1, . . . , [symbol] do | |
| 3: | for batch bₜ ~ [symbol] ₜ do | |
| 4: | Obtain mask m [symbol] of the top [symbol] scores s at each layer | |
| 5: | Compute [symbol] (θ ⊙ m [symbol] bₜ) | |
| 6: | $θ ← θ - η ( \frac{\partial ℒ}{\partial \text{?}} ⊙ ( 1 - {M}_{t - 1} ) )$ | [symbol] Weight update |
| 7: | $s ← s - η ( \frac{\partial ℒ}{\partial \text{?}} )$ | [symbol] Weight score update |
| 8: | end for | |
| 9: | Mₜ ← Mₜ₋₁ [symbol] m [symbol] | [symbol] Accumulate binary mask |

| | |
|---|---|
| 10: | end for |

[symbol]

indicates data missing or illegible when filed

In some embodiments, the subnetwork (i.e., binary mask) for the current task may be selected during learning of the current task. Thus, the continual learning apparatus 200 may determine a binary attention mask m; that represents the optimal subnetwork (i.e., optimal binary mask) for the current task. In some embodiments, the continual learning apparatus 200 may determine the binary attention mask m; describing the optimal subnetwork for the task t such that |mₜ*| is less than a model capacity c, as shown in Equation 8.

$${m}_{i}^{*} = {minimize}_{{m}_{i} ∈ {\{ 0 , 1 \}}^{\vert θ \vert}} \frac{1}{{n}_{t}} {\sum }_{i = 1}^{{n}_{i}} ℒ ( f ( {x}_{i , t} ; θ ⊙ {m}_{t} ) , {y}_{i , t} ) - C \qquad Equation 8$$

$$subject to \vert {m}_{i}^{*} \vert \leq c ,$$

In Equation 8, C denotes a task loss and may be given as in Equation 9, and c<<|θ|.

$$C = ℒ ( f ( {x}_{i , t} ; θ ) , {y}_{i , t} ) \qquad Equation 9$$

As described above, the continual learning apparatus may obtain the binary mask for each task, so the number of binary masks to be stored may increase as the number of tasks increases. In some embodiments, the continual learning apparatus may use a compression algorithm to store the binary masks. In some embodiments, the continual learning apparatus may convert a sequence of binary masks into a single N-bit binary mask, and compress the single N-bit binary mask. In some embodiments, the continual learning apparatus may use a lossless compression algorithm such as Huffman encoding, for compression. For example, the continual learning apparatus may convert the sequence of binary masks into a single accumulated decimal mask, change each integer of the accumulated decimal mask into an ASCII code symbol to generate the N-bit binary mask, and compress the symbol (N-bit binary mask) with the Huffman encoding. In this case, an N-bit-wise Huffman encoding may be performed, where N is a natural number.

For example, it is assumed that the binary mask of each task t is obtained as shown in FIG. 7 where t is an integer between 1 and T. In this case, the continual learning apparatus may generate a single accumulated decimal mask by multiplying the binary mask of task t by 2′, and then adding the binary masks of all tasks, as shown in FIG. 8. In an example of FIG. 8, a mask given by {3, 0, 4, 0, 7+2^{T}, 6+2^{T}, 4, 0, 1} may be the accumulated decimal mask. Next, the continual learning apparatus may convert each integer of the accumulated decimal mask to an ASCII code symbol, and compress the ASCII code symbol using the Huffman encoding. For example, the Huffman encoding may compress the sequence of binary masks into 7-bit binary maps and decompress the 7-bit binary maps to infer without bit loss approximately with a 78% compression rate. The compression ratio may increase sub-linearly with the size of the binary bits.

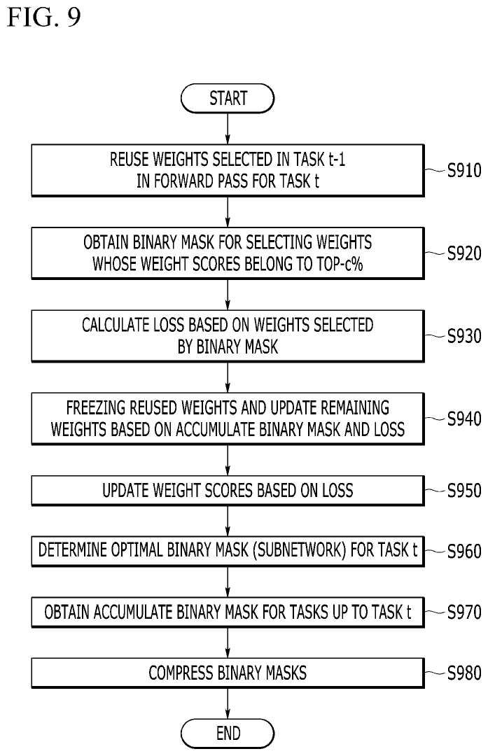

FIG. 9 is a flowchart of a continual learning method according to some embodiments.

In some embodiments, a continual learning apparatus may receive a dataset for each of a plurality of tasks and a target capacity ratio to learn the plurality of tasks. The target capacity ratio may be a value for selecting weights and may be provided for each layer of a neural network. The continual learning apparatus may also randomly initialize weights and weight scores of a continual learning model before learning the plurality of tasks.

Referring to FIG. 9, in learning for task t (current task or first task) of the plurality of tasks, the continual learning apparatus may reuse weights selected in task t-1 (previous task or second task) of the plurality of tasks in a forward pass of task t of the neural network at S910. That is, a plurality of weights used in learning for task t may include the weights selected in the previous task.

The continual learning apparatus may update the plurality of weights excluding the weights selected in the previous task in a backward pass of task t of the neural network, and freeze the weights selected in the previous task at S940. The continual learning apparatus may learn a binary mask together at S950 when learning the weights. The continual learning apparatus may learn the binary mask by learning (i.e., updating) the weight scores.

In some embodiments, the continual learning apparatus may obtain the binary mask by selecting weights from the plurality of weights whose weight scores are in the top-c % at S920, where c is a target capacity ratio. In some embodiments, the continual learning apparatus may obtain the binary mask that selects weights having weight scores belonging to the top c % for each layer. The continual learning apparatus may update the weights based on an accumulate binary mask obtained by accumulating binary masks from an initial task (task 1) to task t-1 at S940. In some embodiments, the continual learning apparatus may calculate a loss based on the weights (i.e., subnetwork) selected by the binary mask and an input batch of the dataset at S930, and update the weights based on the accumulate binary mask and the loss at S940. The reused weights may be frozen by the accumulate binary mask and not updated at S940. Further, the continual learning apparatus may update the weight scores based on the loss calculated in S930 at S950. In some embodiments, the continual learning apparatus may update the weight scores by ignoring the derivatives of the indicator function used in the binary mask at S950.

In some embodiments, the continual learning apparatus may learn task t, the weights, and the weight scores (binary mask) in the neural network by repeating the processes of S910 to S950 for each batch of the dataset for the current task.

In some embodiments, upon completion of learning for task t, the continual learning apparatus may determine a mask (binary attention mask) that represents an optimal subnetwork among the binary masks obtained during learning at S960. Accordingly, the continual learning apparatus may find the subnetwork for the current task t with the optimal binary mask (binary attention mask). In some embodiments, when learning for task t is complete, the continual learning apparatus may accumulate the binary mask (e.g., binary attention mask) for task t over the accumulate binary mask for tasks up to task t-1 to obtain the accumulate binary mask for tasks up to task t at S970.

In some embodiments, the continual learning apparatus may convert the binary masks (e.g., binary attention masks) of the plurality of tasks into a single accumulated mask, and compress the accumulated mask into M-bit binary maps at S980. Here, M is a natural number.

As described above, in the continual learning method according to some embodiments, a neural network may search for task-adaptive winning tickets (i.e., subnetworks) and update weights that have not been trained on the previous tasks. After training for each task, a continual learning model may freeze subnetwork parameters so that the continual learning method may immune to catastrophic forgetting. Furthermore, the continual learning method may selectively transfer previously learned knowledge to a future task (forward transfer), which may substantially reduce the training time it takes to converge during sequential learning. This strength may become more critical to the large-scaled continual learning problems where a continual learning apparatus trains on several tasks in a sequence.

Experimental results describing the effectiveness of the continual learning method according to some embodiments may be found in the inventors' paper “Forget-free Continuous Learning with Winning Subnetworks,” International Conference on Machine Learning, 2022. This paper is hereby incorporated by reference into the present application.

Next, an example computing device for implementing a continual learning apparatus according to some embodiments is described with reference to FIG. 10.

FIG. 10 is a block diagram of a computing device according to some embodiments.

Referring to FIG. 10, a computing device 1000 may include a processor 1010, a memory 1020, a storage device 1030, a communication interface 1040, and a bus 1050. The computing device 1000 may further include other general components.

The processor 1010 may control overall operation of each component of the computing device 1000. The processor 1010 may be implemented with at least one of various processing units such as a central processing unit (CPU), a microprocessor unit (MPU), a micro controller unit (MCU), and a graphic processing unit (GPU), or may be implemented with parallel processing units. In addition, the processor 1010 may perform operations on a program for executing the above-described continual learning method.

The memory 1020 may store various data, commands, and/or information. The memory 1020 may load a computer program from the storage device 1030 to execute the above-described continual learning method. The storage device 1030 may non-temporarily store the program. The storage device 1030 may be implemented as a nonvolatile memory.

The communication interface 1040 may support wired or wireless Internet communication of the computing device 1000. In addition, the communication interface 1040 may support various communication methods other than the Internet communication.

The bus 1050 may provide a communication function between components of the computing device 1000. The bus 1050 may be implemented as various types of buses such as an address bus, a data bus, and a control bus.

The computer program may include instructions that cause the processor 1010 to perform the continual learning method when loaded into the memory 1020. That is, the processor 1010 may perform operations for the continual learning method by executing the instructions.

In some embodiments, the computer program may include instructions of using, in a forward pass of a neural network for learning a current task of a plurality of tasks, a plurality of weights including selected weights, the selected weights being selected in a previous task of the plurality of tasks; freezing the selected weights and updating weights excluding the selected weights from the plurality of weights, in a backward pass of the neural network for learning the current task; obtaining a binary mask for selecting some weights of the plurality of weights based on a weight score of each of the plurality of weights; and finding a subnetwork of the neural network for the current task based on the binary mask.

The continual learning method or apparatus according to some embodiments described above may be implemented as a computer-readable program on a computer-readable medium. In some embodiments, the computer-readable medium may include a removable recording medium or a fixed recording medium. In some embodiments, the computer-readable program recorded on the computer-readable medium may be transmitted to another computing device via a network such as the Internet and installed in another computing device, so that the computer program can be executed by another computing device.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A continual learning method of learning a plurality of task in a sequential order, performed by a computing device, the method comprising:
using, in a forward pass of a neural network for learning a current task of the plurality of tasks, a plurality of weights including selected weights, the selected weights being selected in a previous task of the plurality of tasks;
freezing the selected weights and updating weights excluding the selected weights from the plurality of weights, in a backward pass of the neural network for learning the current task;
obtaining a binary mask for selecting some weights of the plurality of weights based on a weight score of each of the plurality of weights; and
finding a subnetwork of the neural network for the current task based on the binary mask.

2. The method of claim 1, wherein the binary mask selects, as the some weights, weights whose weight scores belong to a top-c % from among the plurality of weights, and wherein the c is a target capacity ratio.

3. The method of claim 2, wherein the binary mask selects, as the some weights, the weights whose weight scores belong to the top-c % for each layer of the neural network.

4. The method of claim 1, wherein the freezing the selected weights comprises freezing the selected weights and updating the weights excluding the selected weights from the plurality of weights, based on an accumulate binary mask obtained by accumulating binary masks obtained in tasks from an initial task to the previous task.

5. The method of claim 4, further comprising calculating a loss based on weights selected by the binary mask,
wherein the freezing the selected weights comprises freezing the selected weights and updating the weights excluding the selected weights from the plurality of weights, based on the accumulate binary mask and the loss.

6. The method of claim 1, further comprising:
calculating a loss based on weights selected by the binary mask, and
updating the weight score based on the loss.

7. The method of claim 1, further comprising obtaining an accumulate binary mask by accumulating binary masks obtained in tasks from an initial task to the current task among the plurality of tasks.

8. The method of claim 1, further comprising:
converting a plurality of binary masks obtained in the plurality of tasks into a single accumulated mask; and
compressing the single accumulated mask into a binary map.

9. The method of claim 8, wherein the single accumulated mask is a decimal mask, and
wherein compressing the single accumulated mask into the binary map comprises:
changing each integer of the decimal mask to an ASCII code to generate an N-bit binary mask; and
compressing the N-bit binary mask using a lossless compression algorithm.

10. A continual learning apparatus comprising:
a memory configured to store one or more instructions; and
a processor configured to, by executing one or more instructions:
use, in a forward pass of a neural network for learning a current task of the plurality of tasks, a plurality of weights including selected weights, the selected weights being selected in a previous task of the plurality of tasks;
freeze the selected weights and update weights excluding the selected weights from the plurality of weights, in a backward pass of the neural network for learning the current task;
obtain a binary mask for selecting some weights of the plurality of weights based on a weight score of each of the plurality of weights; and
find a subnetwork of the neural network for the current task based on the binary mask.

11. The continual learning apparatus of claim 10, wherein the binary mask selects, as the some weights, weights whose weight scores belong to a top-c % from among the plurality of weights, and
wherein the c is a target capacity ratio.

12. The continual learning apparatus of claim 11, wherein the binary mask selects, as the some weights, the weights whose weight scores belong to the top-c % for each layer of the neural network.

13. The continual learning apparatus of claim 10, wherein the processor is further configured to freeze the selected weights and update the weights excluding the selected weights from the plurality of weights, based on an accumulate binary mask obtained by accumulating binary masks obtained in tasks from an initial task to the previous task.

14. The continual learning apparatus of claim 13, wherein the processor is further configured to:
calculate a loss based on weights selected by the binary mask; and
freeze the selected weights and update the weights excluding the selected weights from the plurality of weights, based on the accumulate binary mask and the loss.

15. The continual learning apparatus of claim 10, wherein the processor is further configured to:
calculate a loss based on weights selected by the binary mask, and
update the weight score based on the loss.

16. The continual learning apparatus of claim 10, wherein the processor is further configured to obtain an accumulate binary mask by accumulating binary masks obtained in tasks from an initial task to the current task among the plurality of tasks.

17. The continual learning apparatus of claim 10, wherein the processor is further configured to:
convert a plurality of binary masks obtained in the plurality of tasks into a single accumulated mask; and
compress the single accumulated mask into a binary map.

18. The continual learning apparatus of claim 17, wherein the single accumulated mask is a decimal mask,
wherein the processor is further configured to:
change each integer of the decimal mask to an ASCII code to generate an N-bit binary mask, and
compress the N-bit binary mask using a lossless compression algorithm.

19. A computer program stored in a non-transitory computer-readable storage medium and executed by a computing device, the computer program configuring the computing device to execute:
using, in a forward pass of a neural network for learning a current task of a plurality of tasks, a plurality of weights including selected weights, the selected weights being selected in a previous task of the plurality of tasks;
freezing the selected weights and updating weights excluding the selected weights from the plurality of weights, in a backward pass of the neural network for learning the current task;
obtaining a binary mask for selecting some weights of the plurality of weights based on a weight score of each of the plurality of weights; and
finding a subnetwork of the neural network for the current task based on the binary mask.
